(19) United States
(12) Patent Application Publication
(10) Pub. No.: US 2013/0202854 A1
(43) Pub. Date: Aug. 8, 2013

(54) ENVIRONMENTALLY FRIENDLY ANTI-SLIPPERY PAD

(71) Applicant: CHI-JUNG SU, Tainan (TW)

(72) Inventor: CHI-JUNG SU, Tainan (TW)

(21) Appl. No.: 13/487,259

(22) Filed: Jun. 4, 2012

(30) Foreign Application Priority Data
Feb. 7, 2012 (TW) 101202129

(51) Int. Cl. B32B 3/10

(52) U.S. Cl. 428/172

(57) ABSTRACT

The environmentally friendly anti-slippery pad contains at least an environmentally friendly layer and a graphical pattern is printed on a top side of the environmentally friendly layer. A protection layer is then attached to a top side of the graphical pattern so as to prevent scratches and peeling off. A fabric layer is attached to a bottom side of the environmentally friendly layer. In turn, an anti-slipper layer is attached to a bottom side of the fabric layer. And an anti-slipper embossed pattern is distributed on a bottom side of the anti-slipper layer.

### TECHNICAL FIELD OF THE INVENTION

The present invention is generally related to anti-slippery pads, and more particularly to an environmentally friendly anti-slippery pad.

### DESCRIPTION OF THE PRIOR ART

As shown in FIGS. 1 and 2, a conventional meal pad 10 is usually rigid and made of a plastic material such as Polypropylene (PP). To be more appealing, the meal pad 10 usually has a graphical pattern 20 printed on its top side. Since the meal pad 10 is rigid and has smooth surfaces, the meal pad 10 and the utensils thereon could easily slip off a dining table 30 if the table 30 is tilted or the meal pad 10 is bumped into. In addition, the graphical pattern 20 could be scratched or peeled off after a period of wear and tear. Then the crumbs of the graphical pattern 20 may contaminate the food 50 in the pot 40.

### SUMMARY OF THE INVENTION

Therefore, a novel environmentally friendly anti-slipper pad is provided herein so as to obviate the foregoing shortcomings.

The environmentally friendly anti-slippery pad 1 contains at least an environmentally friendly layer having a graphical pattern printed on a top side and a protection layer attached to a top side of the graphical pattern. A fabric layer is attached to a bottom side of the environmentally friendly layer. In turn, an anti-slipper layer with an anti-slipper embossed pattern is distributed on a bottom side.

The environmentally friendly layer is made of a naturally decomposable material containing fine powders from grinding stone.

The advantages of the present invention are as follows. Firstly, the graphical pattern provides an appealing outlook to the anti-slippery pad, and is protected by the protection layer to prevent scratches and peeling off. Then, the embossed pattern on the anti-slippery layer provides enhanced anti-slippery function.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a top-view diagram showing a conventional meal pad.

FIG. 2 is a perspective diagram showing an application scenario of the meal pad of FIG. 1.

FIG. 3 is a schematic perspective diagram showing the various layers constituting an anti-slippery pad according to an embodiment of the present invention.

FIGS. 4 to 7 illustrate the various steps of producing the anti-slipper pad of FIG. 3, respectively.

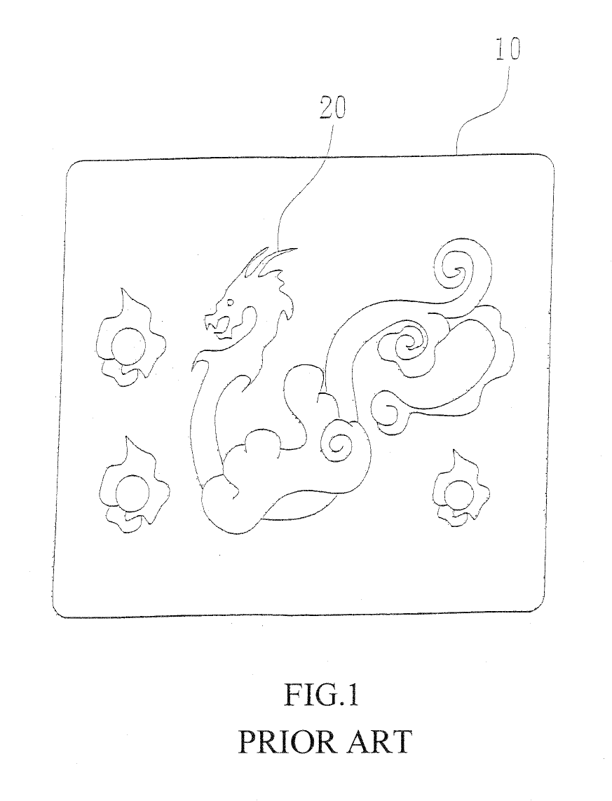

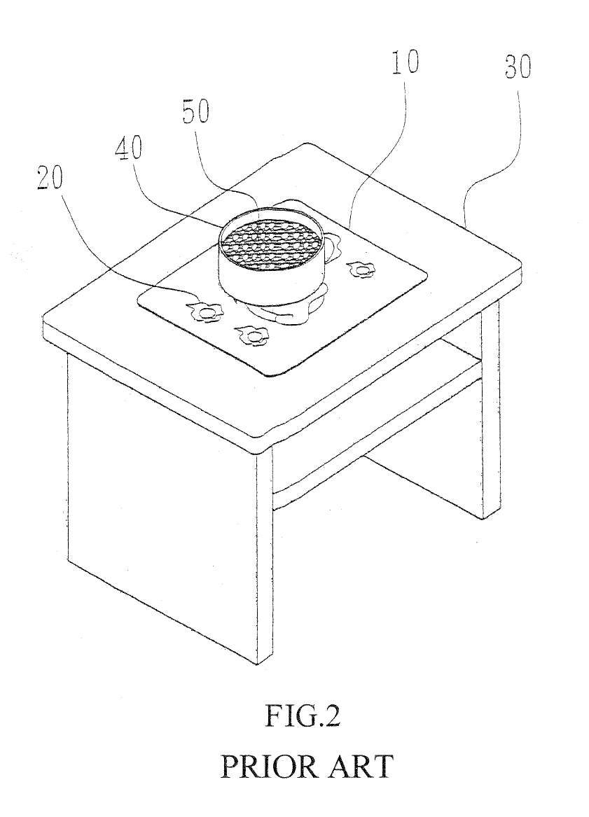

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims

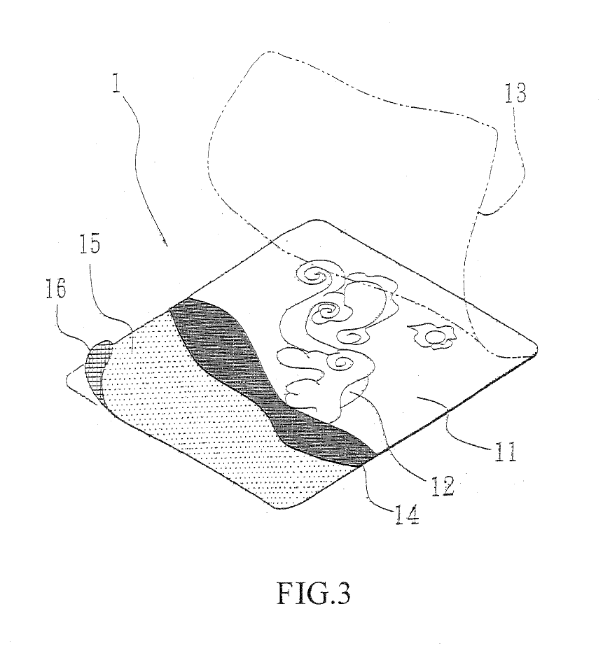

As shown in FIG. 3, an environmentally friendly anti-slippery pad 1 according to an embodiment of the present invention contains at least an environmentally friendly layer 11 and a graphical pattern 12 is printed on a top side of the environmentally friendly layer 11. A protection layer 13 is then attached to a top side of the graphical pattern 12. A fabric layer 14 is attached to a bottom side of the environmentally friendly layer 11. In turn, an anti-slipper layer 15 is attached to a bottom side of the fabric layer 14. And an anti-slipper embossed pattern 16 is distributed on a bottom side of the anti-slipper layer 15.

The environmentally friendly layer 11 is made of a naturally decomposable material containing fine powders from grinding stone (not shown).

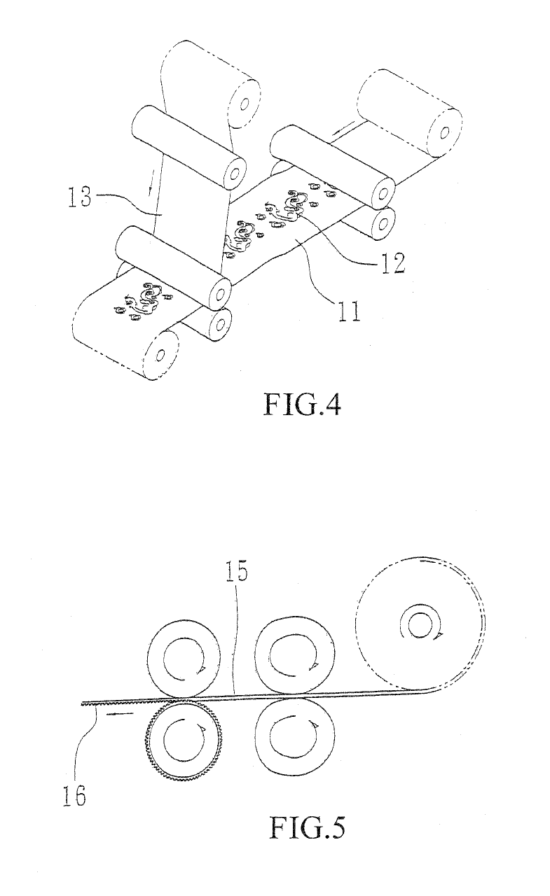

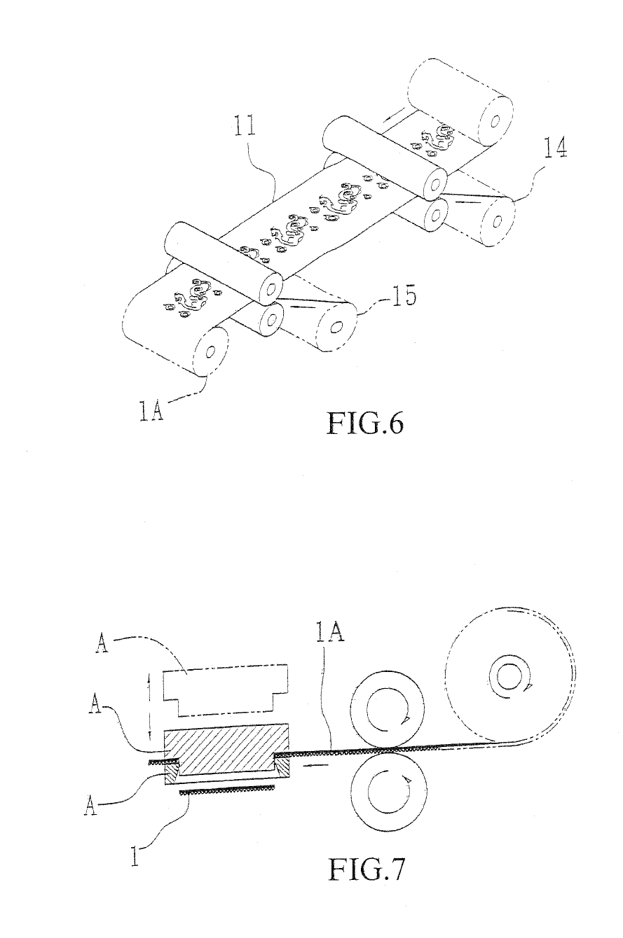

FIGS. 4 to 7 illustrate how the environmentally friendly anti-slipper pad 1 is produced. As shown in FIG. 4, the environmentally friendly layer 11 is run through rollers and, in the process, the graphical pattern 12 is printed on and the protection layer 13 is sealed over the top side of the environmentally friendly layer 11. In the meantime, as shown in FIG. 5, the anti-slipper layer 15 is run through rollers and, in the process, the embossed pattern 16 is impressed to the bottom side of the anti-slipper layer 15. Then, as shown in FIG. 6, the environmentally friendly layer 11 with the graphical pattern 12 is run though rollers and, in the process, the fabric layer 14 and the anti-slippery layer 15 with the embossed pattern 16 are sequentially attached to the bottom side of the environmentally friendly layer 11 into a roll of sheet 1A. As shown in FIG. 7, the roll of sheet 1A is fed through a cutter A and the anti-slipper pads 1 are produced.

The product process described above can be summarized as follows. The top side of the environmentally friendly layer 1 is printed with the graphical pattern 12. The environmentally friendly layer 11 is made of a naturally decomposable material containing fine powders from grinding stone (i.e., eco material made by stone). To avoid scratches to and peeling off of the graphical pattern 12, the protection layer 13 is provided. Beneath the environmentally friendly layer 11, there are sequentially stacked fabric layer 14 and anti-slipper layer 15 with anti-slipper embossed pattern 16. These layers are laminated into a roll of soft sheet 1A, which is cut to the anti-slipper pads 1 of appropriate sizes.

The advantages of the present invention are as follows. Firstly, the graphical pattern 12 provides an appealing outlook to the anti-slippery pad 1, and is protected by the protection layer 13 to prevent scratches and peeling off. Then, the embossed pattern 16 on the anti-slippery layer 15 provides enhanced anti-slippery function.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An environmentally friendly anti-slippery pad, comprising:
an environmentally friendly layer;
a graphical pattern printed on a top side of the environmentally friendly layer;
a protection layer attached to a top side of the graphical pattern;
a fabric layer attached to a bottom side of the environmentally friendly layer;
an anti-slipper layer attached to a bottom side of the fabric layer; and
an embossed pattern distributed on a bottom side of the anti-slipper layer.

2. The environmentally friendly anti-slippery pad according to claim 1, wherein the anti-slippery layer is made of a naturally decomposable material containing fine powders from grinding stone.
